(19) United States
(12) Patent Application Publication
(10) Pub. No.: US 2007/0057956 A1
(43) Pub. Date: Mar. 15, 2007

(54) Method, apparatus, and computer program product for implementing self-modeling computer systems componentry

(75) Inventors: David Joseph Gimpl, Rochester, MN (US); Gregory Richard Hintermeister, Rochester, MN (US); Cale T. Rath, Byron, MN (US); George James Romano, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: International Business Machines Corporation, Armonk, NY (US)

(21) Appl. No.: 11/225,674

(22) Filed: Sep. 13, 2005

(51) Int. Cl. G09G 5/36

(52) U.S. Cl. 345/553

(57) ABSTRACT

A method, apparatus and computer program product are provided for implementing self-modeling of computer systems componentry. Each computer system component includes a scalable vector graphic (SVG). The SVG provides a graphical representation for the respective computer system component. The SVGs are collected and a visual representation of the computer system is generated.

### FIELD OF THE INVENTION

The present invention relates generally to the data processing field, and more particularly, relates to a method, apparatus and computer program product for implementing self-modeling of computer systems componentry.

### DESCRIPTION OF THE RELATED ART

Large computer systems are composed of hundreds of individual parts. Racks also known as frames or cages, support enclosures like drawers or planers, which also provide connections, such as, bus slots and locations for cards, disk units, and the like.

Each one of these components is individually built and participates on a common bus and act together to form the computer system. Each one of these components also contains elements about itself, which is available on the bus as vital product data (VPD), which classically contains information such as, serial number, manufacturer name, version and date of firmware, and sometimes additional descriptive information such as, text string like “Intel Ether Pro 100M” as an example of a product name for a particular line of Ethernet card and chipset.

Inventory systems that probe the bus for all the cards use this VPD information to provide a listing of serial numbers and the like of components in the system, however no information is provided to physically describe the makeup of the system.

A need exists for an effective mechanism for implementing self-modeling of computer systems componentry.

As used in the following description and claims, it should be understood that the term scalable vector graphic (SVG) includes various arrangements of graphical data and vector graphical data.

### SUMMARY OF THE INVENTION

Principal aspects of the present invention are to provide a method, apparatus and computer program product for implementing self-modeling of computer systems componentry. Other important aspects of the present invention are to provide such method, apparatus and computer program product for implementing self-modeling of computer systems componentry substantially without negative effect and that overcome many of the disadvantages of prior art arrangements.

In brief, a method, apparatus and computer program product are provided for implementing self-modeling of computer systems componentry. Each computer system component includes a scalable vector graphic (SVG). The SVG provides a graphical representation for the respective computer system component. The SVGs are collected and a visual representation of the computer system is generated.

In accordance with features of the invention, the SVG for the respective computer system component is stored with vital product data (VPD) on the component. Alternatively, a system memory address or a universal resource locator (URL) for an Internet location for the SVG for the respective computer system component is stored with the VPD on the component.

In accordance with features of the invention, the generated visual representation of the computer system can include predefined attributes, such as color, to visually correlate component failure.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating an exemplary computer system and operating system for implementing self-modeling of computer systems componentry in accordance with the preferred embodiment;

FIG. 2 is a block diagram representation illustrating an exemplary computer system component in accordance with the preferred embodiment;

FIGS. 3, and 4 are flow charts illustrating exemplary steps of methods for implementing self-modeling of computer systems componentry in accordance with the preferred embodiments;

FIG. 5 illustrates an exemplary computer system enclosure with exemplary cards in slots, each including vectored data in accordance with the preferred embodiment;

FIG. 6 is a block diagram illustrating a computer program product in accordance with the preferred embodiment.

### DETAILED DESCRIPTION OF THE PREFERRED EMBODIMENTS

In accordance with features of the preferred embodiments, along with conventional VPD information, a computer system component provides a visual/physical representation of itself when probed for information. This visual/physical representation is optimally in the form of a scalable vector graphic (SVG), so that as each of the devices of a bus report in, a composite image of the physical system advantageously is constructed. In the computer system including multiple individual component parts, each visually describing itself with a respective SVG; the aggregate inventory is instantly capable of graphically modeling any combination of component parts that comprise the system. This self-describing system advantageously is used to provide an instant graphical system representation. Activities such as the system assembly, upgrades, component failure identification, and maintenance advantageously leverage this capability.

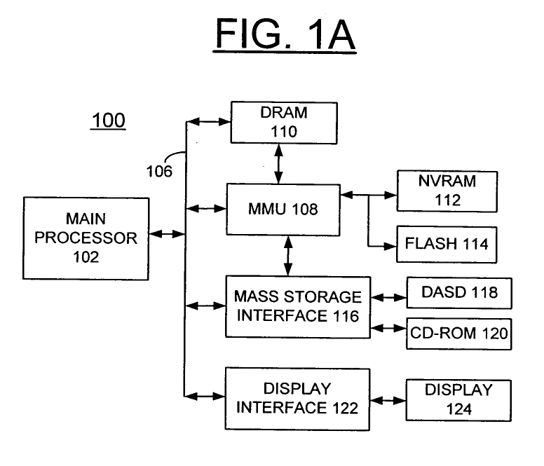

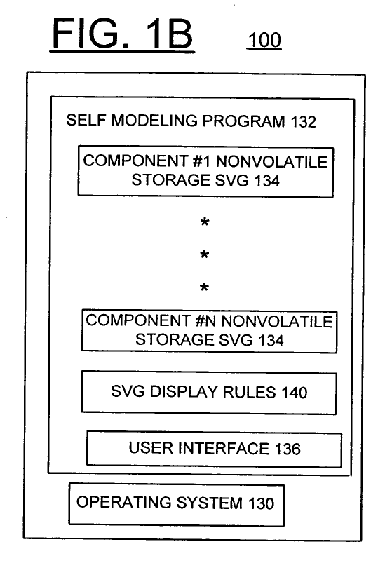

Having reference now to the drawings, in FIGS. 1A and 1B, there is shown an exemplary computer system generally designated by the reference character 100 for implementing self-modeling methods for computer systems componentry in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 1B, computer system 100 includes an operating system 130, a self-modeling program 132, for each component #1-#N a nonvolatile storage scalable vector graphic (SVG) 134 in accordance with the preferred embodiment, and a user interface 136. SVG display rules 140 are identified and stored in accordance with the methods of the preferred embodiment.

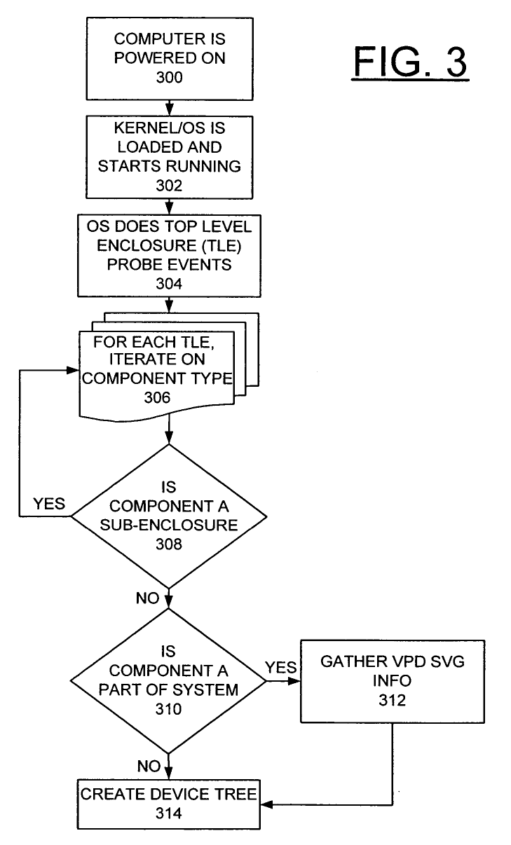

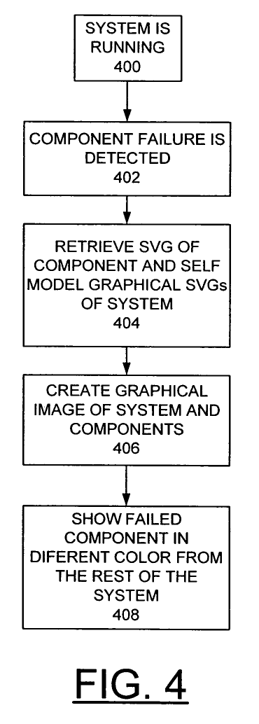

Various commercially available computers can be used for computer system 100, for example, an IBM computer. CPU 102 is suitably programmed by the self-modeling program 132 and the SVG display rules 140 to execute the flowchart of FIGS. 3 and 4 for implementing self-modeling of computer systems componentry in accordance with the preferred embodiment.

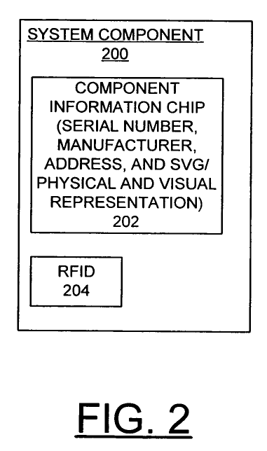

Referring now to FIG. 2, there is shown an exemplary computer system component 200 in accordance with the preferred embodiment. Computer system component 200 includes a component information chip 202 storing, for example, serial number, manufacturer, address and scalable vector graphic (SVG) physical and visual representation of the component. Manufacturers of computer components 200 or computer system 100 advantageously store a vectored graphic representation or SVG of the card itself together with conventional VPD for the component. The computer components 200 typically have chips 202 or areas of nonvolatile storage, such as an EEPROM or a flash memory, which store the firmware/microcode, serial number, MAC address, and the like. These nonvolatile storage areas advantageously are used to contain the graphical data or SVG of the preferred embodiment for that computer component. For example, this SVG data of the preferred embodiment, depending on the visual complexity of the particular computer component 200 would be approximately 2K in size, and is a small enough size to be stored in a nominal sized nonvolatile storage space.

Computer system 100 optionally includes a Radio Frequency IDentification (RFID) tag 204 provided with a computer system component 200, for example, used to identify a part within a homogeneous pool of computer systems 100. For example, with a laptop or other such radio receiver equipment (not shown), a system administrator could locate the particular component in question.

It should be understood that the SVG may not necessarily be stored within the component 200, but rather, for example, can be referenced in a URL fashion. A URL, representing an Internet location of the SVG file, can easily suffice, conserving valuable space in the nonvolatile space 202 of the component 200. Multiple URLs could also be stored, representing the various physical and operating states of the device, such as a failed CD-ROM device depicting open CD shuttle.

In accordance with features of the preferred embodiments, with the computer components 200 containing the SVG data, computer system 100 can be instantly modeled, thus enabling numerous applications in the computer industry. Assembly of computer systems could use the graphically modeling of the system 100 to ensure the various parts are put on the racks/enclosures appropriately. Such visually guided assembly would aid in accuracy, as the person could follow along in pictures what they are physically doing. A visually modeled computer system 100 can provide rapid part location identification, which is helpful in the cases of locating a failed component, and by swapping it out with a new/replacement part.

In accordance with features of the preferred embodiments, with a collection of inventory sampled over periods of time, when a part 200 fails and no longer reports itself, or does with some error code, the visually modeled computer system 100 presents, for example, a flashing red part to guide the operator to locate the part in question. When the part 200 is located and swapped out, the delta in the inventory of visually modeled computer system 100 is visually represented and can be used to verify that the “look” of the new part is similar to that of the “old” part, or if there is a difference, it could provide a visual summary like “you swapped part A for part B, as depicted below”, allowing the operator visual verification to that service activity. The failing part 200 also can provide multiple image (SVG) representations of itself mapping back to physical characteristics of the type of failure. For example, if a CD-ROM device cannot close its tray (i.e. stuck/jammed open), visually modeled computer system 100 can report or render an SVG depicting a CD ROM drive with its shuttle open.

Referring now to FIG. 3, there are shown exemplary steps of methods for implementing self-modeling of computer systems componentry in accordance with the preferred embodiment starting at a block 300 with the computer being powered on. Next the operating system 130 is loaded and starts running as indicated in a block 302. The operating system 130 performs top-level enclosure (TLE) probe events as indicated in a block 304. For each TLE, iterating on each component type as indicated in a block 306 checking is performed to determine if component is a sub-enclosure as indicated in a decision block 308. If the component is a sub-enclosure, then iterating on each component type is performed at block 306. Next checking is performed to determine whether the component is part of the computer system as indicated in a decision block 310. When the component is part of the computer system, then the SVG is collected as indicated in a block 312. The SVGs for the computer system components are combined to create a device tree or computer system model for the computer system as indicated in a block 314.

Referring now to FIG. 4, there are shown exemplary steps of methods for utilizing self-modeling of computer systems componentry in accordance with the preferred embodiment starting at a block 400 with the system running. As indicated in a block 402, a component failure is detected. The SVG of the failed component is retrieved together with the self-model graphical system representation or SVGs tree of the system as indicated in a block 404. A graphical image of the system and components is created as indicated in a block 406. The failed component is highlighted, such as shown in a different color from the rest of the system as indicated in a block 408.

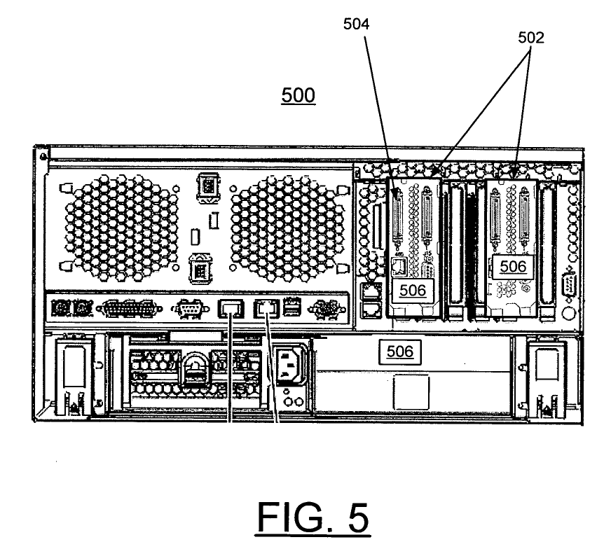

FIG. 5 illustrates an exemplary computer system enclosure generally designated by the reference character 500 with a pair of exemplary cards 502 located within one or more respective slots or connectors 504, each including vectored data VPD storage indicated by a respective block 506 in accordance with the preferred embodiment. VPD storage 506 either stores a respective SVG for the computer system component 500, 502 or an address for the respective SVG. The stored SVG address can be a system memory address or a URL for example, such as, http://www.ibm.com/100MegEthernet.svg.

The components 500, 502 of computer system 100 could also emit its VPD via RFID tags, for example, included with VPD storage 506. RFID tags are now generally inexpensive. For example, an operator with a wireless-enabled laptop that has the inventory as gathered by a particular computer system 100 with its componentry reporting SVG on the common bus, as the new component is within proximity of the particular computer system 100 to receive the new component, the wireless-enabled laptop can detect the new device, and begin to visually depict and guide the correct insertion point into the computer system 100.

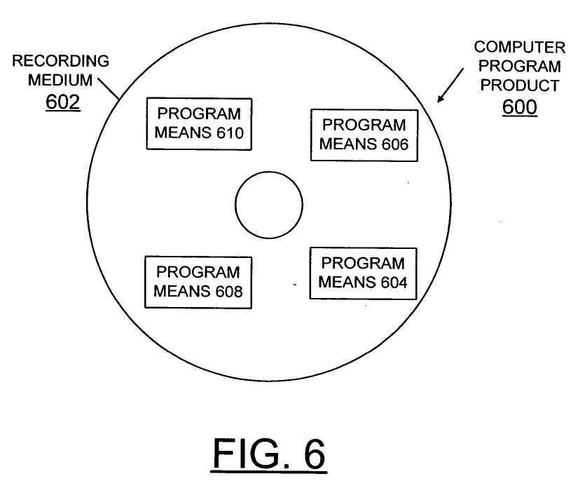

Referring now to FIG. 6, an article of manufacture or a computer program product 600 of the invention is illustrated. The computer program product 600 includes a recording medium 602, such as, a floppy disk, a high capacity read only memory in the form of an optically read compact disk or CD-ROM, a tape, a transmission type media such as a digital or analog communications link, or a similar computer program product. Recording medium 602 stores program means 604, 606, 608, 610 on the medium 602 for carrying out the methods for implementing self-modeling of computer systems componentry of the preferred embodiment in the system 100 of FIGS. 1A and 1B.

A sequence of program instructions or a logical assembly of one or more interrelated modules defined by the recorded program means 604, 606, 608, 610, direct the computer system 100 for implementing self-modeling of computer systems componentry of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing self-modeling of computer systems componentry comprising:
providing a scalable vector graphic (SVG) for a plurality of computer system components in a computer system; said SVG providing a graphical representation for the plurality of respective computer system components;
collecting said SVGs for the computer system components; and
generating a visual representation of the computer system.

2. A method for implementing self-modeling of computer systems componentry as recited in claim 1 further comprising identifying a failed computer system component in said computer system and updating said generated visual representation of said computer system to indicate said failed computer system component.

3. A method for implementing self-modeling of computer systems componentry as recited in claim 2 wherein updating said generated visual representation of the computer system includes rendering said failed computer system component in a different color from other components of said computer system.

4. A method for implementing self-modeling of computer systems componentry as recited in claim 1 wherein providing said scalable vector graphic (SVG) for the plurality of each computer system components includes storing said SVG with vital product data (VPD) on the component.

5. A method for implementing self-modeling of computer systems componentry as recited in claim 1 wherein providing said scalable vector graphic (SVG) for the plurality of computer system components includes storing a system memory address for said SVG with vital product data (VPD) on the component.

6. A method for implementing self-modeling of computer systems componentry as recited in claim 1 wherein providing said scalable vector graphic (SVG) for the plurality of computer system components includes storing a universal resource locator (URL) for an Internet location for said SVG with vital product data (VPD) on the component.

7. A method for implementing self-modeling of computer systems componentry as recited in claim 1 wherein generating said visual representation of the computer system further includes updating said visual representation of the computer system with predefined attributes to visually indicate a component failure.

8. A method for implementing self-modeling of computer systems componentry as recited in claim 1 wherein providing said scalable vector graphic (SVG) for the plurality of computer system components includes providing a Radio Frequency IDentification (RFID) tag with a computer system component.

9. A computer program product for implementing self-modeling of computer systems componentry in a computer system, said computer program product including instructions executed by the computer system to cause the computer system to perform:
providing a scalable vector graphic (SVG) for each computer system component in a computer system; each said SVG providing a graphical representation for each respective computer system component;
collecting said SVGs for the computer system components; and
generating a visual representation of the computer system.

10. A computer program product for implementing self-modeling of computer systems componentry as recited in claim 9 further comprising identifying a failed computer system component in said computer system and updating said generated visual representation of said computer system to indicate said failed computer system component.

11. A computer program product for implementing self-modeling of computer systems componentry as recited in claim 10 wherein updating said generated visual representation of the computer system includes rendering said failed computer system component in a different color from other components of said computer system.

12. A computer program product for implementing self-modeling of computer systems componentry as recited in claim 9 wherein providing said scalable vector graphic (SVG) for each computer system component includes storing said SVG with vital product data (VPD) on the component.

13. A computer program product for implementing self-modeling of computer systems componentry as recited in claim 9 wherein providing said scalable vector graphic (SVG) for each computer system component includes storing a system memory address for said SVG with vital product data (VPD) on the component.

14. A computer program product for implementing self-modeling of computer systems componentry as recited in claim 9 wherein providing said scalable vector graphic (SVG) for each computer system component includes storing a universal resource locator (URL) for an Internet location for said SVG with vital product data (VPD) on the component.

15. A computer program product for implementing self-modeling of computer systems componentry as recited in claim 9 wherein generating said visual representation of the computer system further includes updating said visual representation of the computer system with predefined attributes to visually indicate a component failure.

16. Apparatus for implementing self-modeling of computer systems componentry comprising:
a scalable vector graphic (SVG) for each computer system component in a computer system; each said SVG providing a graphical representation for each respective computer system component;
a self-modeling program for collecting said SVGs for the computer system components; and
said self-modeling program for generating a visual representation of the computer system.

17. Apparatus for implementing self-modeling of computer systems componentry as recited in claim 16 wherein said self-modeling program, responsive to identifying a failed computer system component in said computer system, for updating said generated visual representation of said computer system to indicate said failed computer system component.

18. Apparatus for implementing self-modeling of computer systems componentry as recited in claim 16 includes non-volatile storage storing one of said SVG or a memory location for said SVG with vital product data (VPD) on the component.

19. Apparatus for implementing self-modeling of computer systems componentry as recited in claim 16 includes non-volatile storage storing a universal resource locator (URL) for an Internet location for said SVG with vital product data (VPD) on the component.

20. Apparatus for implementing self-modeling of computer systems componentry as recited in claim 16 includes a Radio Frequency IDentification (RFID) tag with a computer system component for providing said scalable vector graphic (SVG).
